(19) United States
(12) Patent Application Publication
(10) Pub. No.: US 2015/0103010 A1
(43) Pub. Date: Apr. 16, 2015

(54) Keyboard with Integrated Pointing Functionality

(71) Applicant: Microsoft Corporation, Redmond, WA (US)

(72) Inventors: Lintao Zhang, Beijing (CN); Magnetro (Li Wen) Chen, Beijing (CN)

(73) Assignee: Microsoft Corporation, Redmond, WA (US)

(21) Appl. No.: 14/052,369

(22) Filed: Oct. 11, 2013

(51) Int. Cl. G06F 3/02; G06F 3/041

(52) U.S. Cl. CPC G06F 3/02; G06F 3/041
USPC 345/168

(57) ABSTRACT

In some examples, pointing functionality is integrated with one or more keys of a keyboard. For instance, a precision pointing surface can be integrated with a key, such as the “J” key, that allows a user to manipulate a pointer on a display. In some situations, one or more touch-sensitive surfaces can also be integrated on other keys to provide clicking functionality. For example, a touch-sensitive surface can be integrated onto a left portion of a spacebar to allow left clicking capability and a touch-sensitive surface can be integrated onto a right portion of the spacebar to allow right clicking capability. In some instances, one or more touch-sensitive surfaces can be used to enable and disable the precision pointing surfaces and other touch-sensitive surfaces.

### BACKGROUND

Input devices, such as keyboards, are used to provide information to computing systems. For example, keyboards are often used to provide input for word processor applications, spreadsheet applications, database applications, internet applications, etc. Typically, a pointing device, such as a mouse, is also used to provide input to software applications. For some computers, such as laptops, a pointing device is built in near the keyboard to provide pointing functionality (e.g., touchpad, trackball). In some cases, a touch screen allows a user to manipulate graphical objects by contacting the screen. In order for a user to access these pointing devices, the user must move a hand away from the keyboard. Such movement creates tension in muscles, which can lead to discomfort and repetitive strain injuries.

### SUMMARY

Implementations described herein provide for pointing functionality that is integrated with one or more keys of a keyboard. For instance, a precision pointing surface can be integrated with a key, such as the “J” key, that allows a user to manipulate a pointer on a display. In some examples, one or more touch-sensitive surfaces can also be integrated on other keys to provide clicking functionality. For example, a touch-sensitive surface can be integrated onto a left portion of a spacebar to allow left clicking capability and a touch-sensitive surface can be integrated onto a right portion of the spacebar to allow right clicking capability. In some instances, one or more touch-sensitive surfaces can be used to enable and disable the precision pointing surfaces and other touch-sensitive surfaces.

This Summary is provided to introduce a selection of concepts in a simplified form that are further described below in the Detailed Description. This Summary is not intended to identify key or essential features of the claimed subject matter; nor is it to be used for determining or limiting the scope of the claimed subject matter.

### BRIEF DESCRIPTION OF THE DRAWINGS

The detailed description is set forth with reference to the accompanying drawing figures. In the figures, the left-most digit(s) of a reference number identifies the figure in which the reference number first appears. The use of the same reference numbers in different figures indicates similar or identical items or features.

FIG. 1 is a block diagram illustrating an example environment including select components for providing a keyboard with integrated pointing functionality according to some implementations.

FIG. 2 is a block diagram illustrating a representative host device that is used with a keyboard that provides integrated pointing functionality according to some implementations.

FIG. 3 illustrates an example of providing integrated pointing functionality on a keyboard according to some implementations.

FIG. 4 is a flow diagram of an example process of providing integrated pointing functionality on a keyboard according to some implementations.

### DETAILED DESCRIPTION

Keyboard with Integrated Pointing Functionality

The technologies described herein are generally directed toward a keyboard with integrated pointing functionality. As used herein, a keyboard can by any type of device that has one or more keys that are used to provide input to a computing device. For example, the one or more keys can be pressed, pushed, or touched in order to provide input. For example, input can be one or more characters or a representation of one or more characters that is received from a keyboard and is to be delivered to a computing device. For instance, a user may cause one or more characters to be sent to an operating system or an application by pressing or touching one or more keys or locations on a keyboard. An application can be a software program executing on a computer system, such as word processor applications, spreadsheet applications, database applications, internet applications, etc.

As used herein, pointing functionality is the functionality to manipulate a pointer on a display and to perform actions associated with the pointer. For example, a pointing device can be used to move a pointer on a display and to provide “clicking” input by pressing one or more buttons or locations on the pointing device. For example, a pointing icon on a display can be moved over a “send” button on a display and a button can be pressed in order to press or activate the “send” button functionality on the display to send an email.

In some implementations, pointing functionality is integrated with one or more keys of a keyboard. A keyboard can be a standard physical keyboard, a low profile or slim keyboard, an interactive interface or display, or any type of device that has one or more keys that are used to provide input to a computing device. In some implementations, a key can include a keycap and an electrical switch (e.g., scissor switch, mechanical switch, membrane switch). In some implementations, pointing functionality or touch input is provided by one or more sensors that are integrated with the one or more keys. For example, a touch-sensitive sensor can be affixed to the top surface of a key cap or located within or near the surface of the key. In some implementations, the sensor provides input in response to detecting a touch (e.g., a user's finger or other suitable object). In some implementations, the sensor provides input in response to detecting movement of touch (e.g., a user's finger or other suitable object moving along the sensor or key).

In some implementations, a user may enable and disable pointing functionality. For example, one or more sensors on one or more of the keys or input associated with the one or more sensors may be enabled or disabled in response to an enabling or disabling input, respectively. Thus, in some implementations, input from the one or more sensors can be used or ignored, depending on whether the sensors are enabled or disabled. In some examples, pressing or touching a combination of one or more keys can toggle pointing functionality on and off. In some implementations, touching one or more keys for a threshold amount of time enables or disables pointing functionality.

By merging pointing functionality with one or more keys of a keyboard, muscle movements can be minimized. For example, elbow movements can be minimized, potentially reducing the chance of repetitive stress injuries (RSI). Professional computer users, such as programmers and other office workers, can benefit from using such a keyboard with integrated pointing functionality. Furthermore, such a keyboard can take up less space than traditional computers or laptops that have separate pointing devices. Therefore, a keyboard with integrated pointing functionality can be well-suited for space constrained applications, such as small laptops and portable keyboards.

### Example Environment

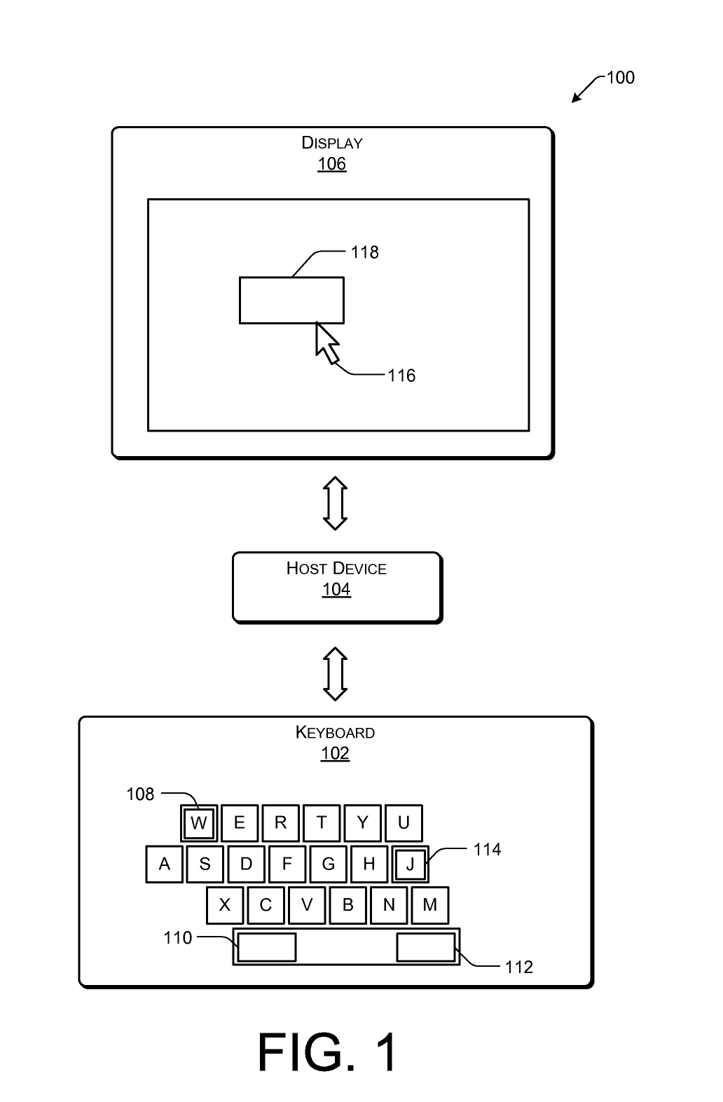

FIG. 1 is a block diagram illustrating an example environment 100 including select components for providing a keyboard with integrated pointing functionality according to some implementations. The environment 100 can include various modules and functional components for performing the functions described herein. In the example, the environment 100 includes a keyboard 102. In the illustrated example, the keyboard 102 is a QWERTY-layout keyboard, wherein each key includes a keycap and electrical switch. In other implementations, other types of keyboards can be used, as discussed above. The environment 100 includes a host device 104, which can comprise any type of computing system capable of receiving input from the keyboard 102 and providing output to a display 106.

In the illustrated example, touch-sensitive elements are integrated onto keycaps to create sensors, making the surface of such keycaps touch sensible. For example, touch-sensitive surfaces 108, 110, and 112 (sensors) can sense whether or not a finger is touching (e.g., on or off the surface). In some implementations, touch-sensitive surfaces 108, 110, and 112 use a capacitive sensing technology for sensing. Another example of the touch-sensitive elements is the precision pointing surface 114 that can sense finger movement or gliding along the surface (e.g., X-Y coordinates). In some implementations, a precision pointing surface 114 (sensor) uses capacitive sensing with grid electrodes. In other implementations, precision pointing surface 114 uses optical sensing (e.g., optical finger navigation technology (OFN)), with a sensor facing toward the top side of the “J” keycap in order to track movement of a finger.

In the illustrated example, touch-sensitive surface 108, integrated with the “W” key, is used for enabling pointing functionality and touch-sensitive surfaces 110 and 112 are used for left clicking and right clicking, respectively. As used herein, touching a key or keycap means that a finger or other object touches the key or keycap without enabling key switching. Thus, the key or keycap is moved less than a threshold distance. As used herein, pressing a key or keycap means that that the key or keycap is pressed or moved at least a threshold distance that is sufficient for activating the key switch mechanism.

In some implementations, pressing a key or keycap provides input associated with a character (e.g., a letter), number, or symbol, or other input that is not associated with the pointing functionality. For example, pressing a key or keycap provides input that is not associated with a pointer (e.g., not associated with: moving a pointer, functionality associated with the pointer, clicking, left-clicking, right-clicking, etc.).

In the illustrated example, a user's left fingers can rest on the ASDF keys without interacting with any touch-sensitive elements. Furthermore, the user can type by pressing any of the keys, without triggering the pointing device. To enable pointing functionality associated with precision pointing surface 114, a user can touch the touch-sensitive surface 108. In some implementations, the precision pointing surface 114 is enabled after touching the touch-sensitive surface 108 for at least a threshold amount of time (e.g., 0.5 seconds or 1 second). Thus, accidental activation of the precision pointing surface 114 can be avoided if the user's intent is to type the letter “W.” In some implementations, the precision pointing surface 114 is enabled as long as the touch-sensitive surface 108 is being touched (e.g., by a finger), and the precision pointing surface 114 is disabled when touch is removed from the touch-sensitive surface 108 (e.g., by moving the finger away). In some implementations, enabling and disabling the precision pointing surface 114 may be accomplished through the use of a touch-sensitive surface located somewhere other than on a key (e.g., below the spacebar or another area).

After the precision pointing surface 114 is enabled, moving a finger (e.g., an index finger) along the surface of the “J” key causes a pointer 116 on the display 106 to move. Furthermore, touching touch-sensitive surface 110 and 112 causes left-click and/or right-click input, similar to a left-click and/or right-click input received from a computer mouse. For example, a button 118 on the display 106 can be activated by touching touch-sensitive surface 110 or touch-sensitive surface 112. Furthermore, double-clicks can be performed by touching touch-sensitive surface 110 or touch-sensitive surface 112 twice. A right-click input may be interpreted to cause display of a context-sensitive menu. In some implementations, clicking functionality may be accomplished through the use of a touch-sensitive surface located somewhere other than on a key (e.g., below the spacebar or another area).

In some implementations, disabling the precision pointing surface 114 can be achieved by removing touch from the touch-sensitive surface 108. In other implementations, disabling the precision pointing surface 114 can be achieved by touching the touch-sensitive surface 108 again (e.g., as a toggle key for enabling/disabling). In some implementations, disabling the precision pointing surface 114 can be achieved by touching the touch-sensitive surface 108 again for at least a threshold amount of time (e.g., approximately 0.5 seconds or 1 second).

In some implementations, enabling or disabling the precision pointing surface 114 can be achieved in many other ways, such as by touching one or more other sensors or keys for a threshold amount of time. Furthermore, in some implementations, enabling or disabling the precision pointing surface 114 can be achieved by pressing one or more keys. For example, instead of the “W” key, the “E” key can be used for enabling. For a left-handed person, a precision pointing surface may be on the “F” key. Thus, one or more precision pointing surfaces may be located on one or more other keys. In some implementations, a precision pointing surface spans multiple keys. For example, the “Y,” “U,” “H,” “J,” “N,” and “M” keys may each have a precision pointing surface. Moreover, each of the surfaces can cause different movement ranges of the pointer 116 on the display 106 (e.g., different sensitivities). Thus, the pointing range can be enlarged by using multiple precision pointing surfaces on multiple keys.

In some implementations, software such as a device driver can be used to configure touch-sensitive elements on one or more of the keys of the keyboard 102. Furthermore, in some implementations, one or more sensors with touch-sensitive elements or surfaces can be arranged or manufactured in that they correspond with one or more respective keys of a keyboard. For example, a set of keycaps or key covers with touch-sensitive elements or surfaces can be installed on a keyboard. Thus, one or more sensors can be configured for use with a keyboard to provide the pointing functionality, clicking functionality, and enabling/disabling functionality described above.

### Example Computing System

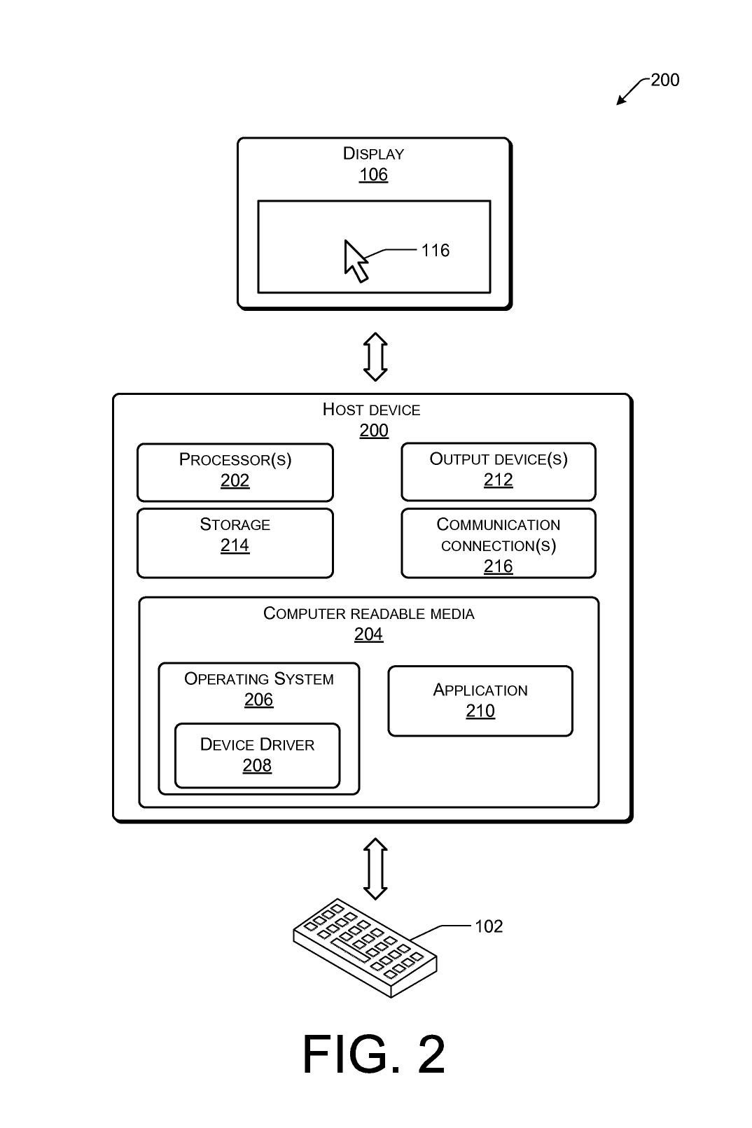

FIG. 2 is a block diagram illustrating a representative host device 200 that is used with a keyboard that provides integrated pointing functionality according to some implementations. The host device 200 is an example of the host device 104 of FIG. 1. The host device 200 can be a computer, server, client system, laptop, mobile device, or any other computing system suitable for being used as a host for interacting with the keyboard 102. The host device 200 shown in FIG. 2 is only one example of a computing device and is not intended to suggest any limitation as to the scope of use or functionality of the computer and associated architectures.

In the illustrated example, the host device 200 includes one or more processors 202 and one or more computer-readable media 204 that includes an operating system 206, a device driver 208 and an application 210.

In some implementations, the device driver 208 or other component of the operating system 206 receives input from the keyboard. The input can include input from sensors, such as the touch-sensitive surfaces 108, 110, and 112 and the precision pointing surface 114. The host device 200 may then cause the pointer 116 to move on the display 106, may cause an action associated with the pointer (e.g., a left or right clicking input), or may enable/disable one or more touch-sensitive surfaces or precision pointing surfaces.

In some implementations, the operating system 206 sends the input from one or more touch-sensitive surfaces or precision pointing surfaces to the application 210. The host device 200 may also include one or more additional output devices 210, storage 214, and one or more communication connections 216. Furthermore, the above components of the host device 200 are able to communicate through a system bus or other suitable connection.

In some implementations, the processor 202 is a microprocessing unit (MPU), a central processing unit (CPU), or other processing unit or component known in the art. Among other capabilities, the processor 202 can be configured to fetch and execute computer-readable processor-accessible instructions stored in the computer-readable media 204 or other computer-readable storage media. Communication connections 216 allow the device to communicate with other computing devices, such as over a network. These networks can include wired networks as well as wireless networks.

As used herein, “computer-readable media” includes computer storage media and communication media. Computer storage media includes volatile and non-volatile, removable and non-removable media implemented in any method or technology for storage of information, such as computer-readable instructions, data structures, program modules, or other data. Computer storage media includes, but is not limited to, random access memory (RAM), read only memory (ROM), electrically erasable programmable ROM (EEPROM), flash memory or other memory technology, compact disk ROM (CD-ROM), digital versatile disks (DVD) or other optical storage, magnetic cassettes, magnetic tape, magnetic disk storage or other magnetic storage devices, or any other medium that can be used to store information for access by a computing device.

In contrast, communication media can embody computer-readable instructions, data structures, program modules, or other data in a modulated data signal, such as a carrier wave. As defined herein, computer storage media does not include communication media.

Computer-readable media 204 can include various modules and functional components for enabling the host device 200 to perform the functions described herein. In some implementations, computer-readable media 204 can include the operating system 206, the device driver 208 and the application 210. The operating system 206, the device driver 208 and the application 210 can include a plurality of processor-executable instructions, which can comprise a single module of instructions or which can be divided into any number of modules of instructions. Such instructions can further include, for example, drivers for hardware components of the host device 100.

The operating system 206, the device driver 208 and/or the application 210 can be entirely or partially implemented on the host device 200. Although illustrated in FIG. 2 as being stored in computer-readable media 204 of host device 200, the operating system 206, the device driver 208 and the application 210, or portions thereof, can be implemented using any form of computer-readable media that is accessible by the host device 200. In some implementations, the operating system 206, the device driver 208 and/or the application 210 are implemented partially on another device or server. Furthermore, computer-readable media 204 can include other modules, such as other device drivers, program data, and the like, as well as data used by the operating system 206, the application 210 and other modules.

Computer-readable media 204 or other machine-readable storage media stores one or more sets of instructions (e.g., software) embodying any one or more of the methodologies or functions described herein. The instructions can also reside, completely or at least partially, within the computer-readable media 204 and within the processor 202 during execution thereof by the host device 200. The program code can be stored in one or more computer-readable memory devices or other computer-readable storage devices, such as computer-readable media 204. Further, while an example device configuration and architecture has been described, other implementations are not limited to the particular configuration and architecture described herein. Thus, this disclosure can extend to other implementations, as would be known or as would become known to those skilled in the art.

### Example of Providing Integrated Pointing Functionality

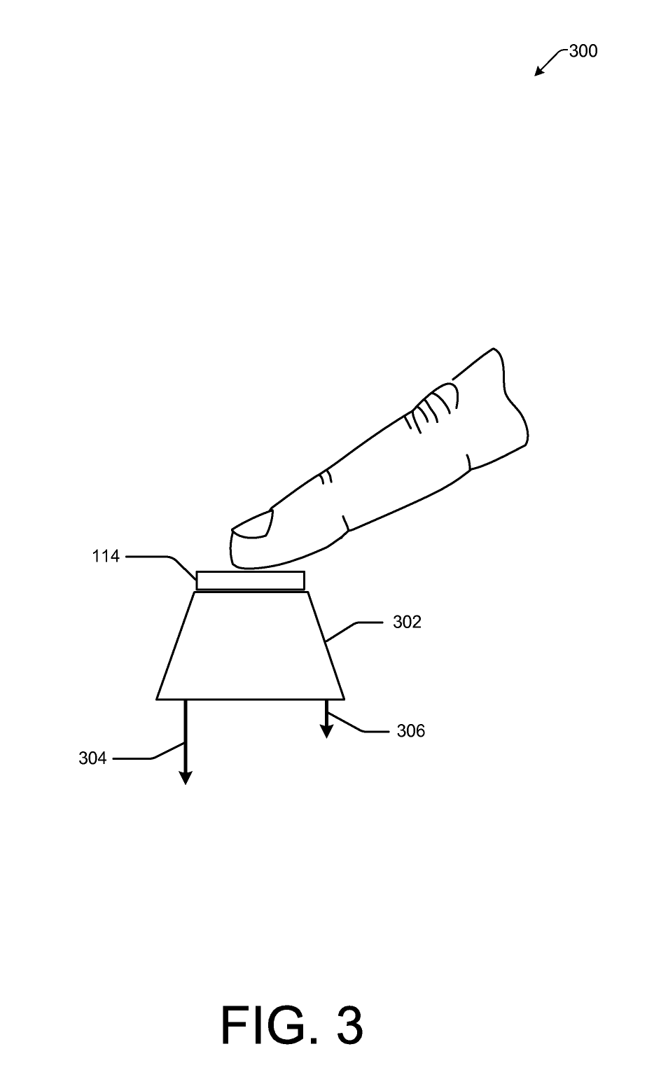

FIG. 3 illustrates an example 300 of providing integrated pointing functionality on a keyboard according to some implementations. In the example, a key 302 is an example of the “J” key of the keyboard 102 of FIG. 1 with the precision pointing surface 114 integrated with the key 302. In some illustrations, the key 302 is an example of one of touch-sensitive surfaces 108, 110, and 112. Therefore, the discussion below with respect to the precision pointing surface 114 may also apply to one of touch-sensitive surfaces 108, 110, and 112 or any other touch-sensitive element associated with a key of the keyboard 102.

In the illustrated example, the precision pointing surface 114 is located on top of the key 302 (e.g., on top of the key cap). In some implementations, the precision pointing surface 114 is built into the key 302 or can be integrated with key in any other way suitable for detecting touch input and movement of touch input. In the illustrated example, threshold distance 304 is the distance that the key 302 must be pressed or moved in order to input data associated with the key 302. For example, to input the character “J,” the key 302 is pressed at least the threshold distance 304. In some implementations, the threshold distance 304 is the minimum distance required to activate a switch associated with the key 302 for entering input.

In some implementations, a threshold distance 306 is the maximum distance that the key 302 can be pressed or moved in order for the precision pointing surface 114 to provide pointing functionality. Thus, if the key 302 is pressed or moved beyond the threshold distance 306, then the precision pointing surface 114 will be disabled. Therefore, if a user inputs the character “J,” the user will not accidentally implement pointer functionality (e.g., moving a mouse curser) at the same time as entering a character. In some implementations, the threshold distance 304 and the threshold distance 306 are approximately equal. Furthermore, in some implementations, a user can input a character using a key at the same time as implementing pointer functionality or other touch-related functionality associated with the key.

### Example Process

In the following flow diagrams, each block represents one or more operations that can be implemented in hardware, software, or a combination thereof. In the context of software, the blocks represent computer-executable instructions that, when executed by one or more processors, cause the processors to perform the recited operations. Generally, computer-executable instructions include routines, programs, objects, components, data structures, and the like that perform particular functions or implement particular abstract data types. The order in which the blocks are described is not intended to be construed as a limitation, and any number of the described operations can be combined in any order and/or in parallel to implement the process. While several examples are described herein for explanation purposes, the disclosure is not limited to the specific examples, and can be extended to additional devices, environments, applications and settings. For discussion purposes, the processes below are described with reference to the environment 100 of FIG. 1, although other devices, systems, frameworks, and environments can implement this process.

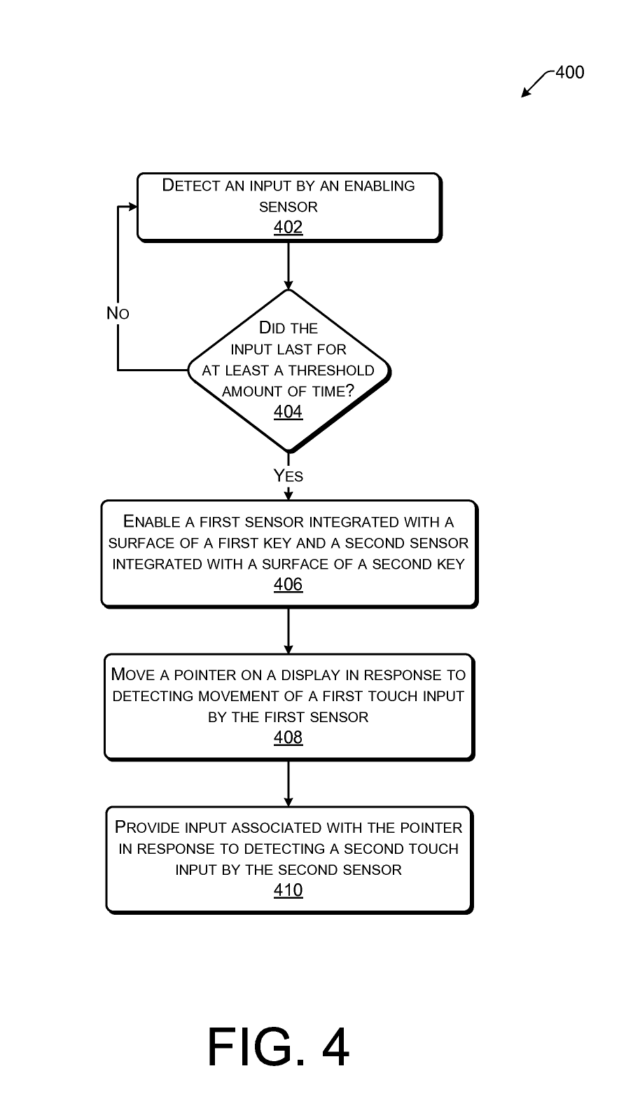

FIG. 4 is a flow diagram of an example process 400 of providing integrated pointing functionality on the keyboard 102 according to some implementations. The steps are performed by sensors or the operating system 206. In some implementations, the steps are performed by another component of the host device 200, such as the application 210. In some examples, one or more of the steps are performed by the keyboard 102 (e.g., software, hardware, or a combination of hardware and software of the keyboard 102). Thus, logic in the keyboard 102 can perform one or more or all of the steps. For example, the modules and corresponding functionality of the host device 200 can be incorporated into the keyboard 102. Furthermore, in some implementations, the display 106 may also be incorporated into the keyboard 102.

At 402, an enabling sensor detects a touch input and produces a touch input signal sent to the host device 200. In some implementations, the enabling sensor is integrated with one or more keys of the keyboard 102. At 404, if the operating system 206 determines that the detected touch input lasts for at least a threshold amount of time, then at 406 the operating system 206 enables a first sensor integrated with a surface of a first key of the keyboard 102 and a second sensor integrated with a surface of a second key of the keyboard 102. For example, touch-sensitive surfaces 108, 110, and 112 and the precision pointing surface 114 are enabled. At 404, if the operating system 206 determines that the detected input does not last for at least a threshold amount of time, then the process returns to 402. In some implementations, the first sensor and the second sensor are enabled in response to two or more of the keys of the keyboard 102 being pushed or pressed at least a threshold distance at approximately the same time.

At 408, the operating system 206 moves a pointer on the display 106 in response to the host device 200 receiving the first touch input signal from the first sensor detecting movement of a first touch input along a surface of the first key or parallel to the surface of the first key. For example, the operating system 206 can move the pointer 116 in response to the precision pointing surface 114 detecting movement of the first touch input on the “J” key. Thus, the first sensor is capable of detecting the first touch input at multiple locations of the surface of the first key.

At 410, the operating system 206 a touch input signal associated with the pointer 116 in response to the second sensor detecting a second touch input on a surface of second key. Thus, the operating system 206 interprets a second touch input on a second sensor as input that is associated with the first touch input for moving the pointer. For example, the operating system 206 can provide a left-click input or left-click command in response to the touch-sensitive surface 110 detecting a second touch input on a left area of the space bar of the keyboard 102. As another example, the operating system 206 can providing a right-click input or right-click command in response to the touch-sensitive surface 112 detecting a second touch input on a right area of the space bar of the keyboard 102.

In some implementations, the operating system 206 also determines that a touch input occurs in response to determining that the first touch input, the second touch input, or the enabling touch input does not move the respective key a second threshold distance. For example, the operating system 206 can provide a right-click input or right-click command in response to the touch-sensitive surface 112 detecting a second touch input on a right area of the space bar of the keyboard 102 that does not cause the space bar of the keyboard 102 to move the second threshold distance.

The example environments, systems and computing devices described herein are merely examples suitable for some implementations and are not intended to suggest any limitation as to the scope of use or functionality of the environments, architectures and frameworks that can implement the processes, components and features described herein. Thus, implementations herein are operational with numerous environments or architectures, and can be implemented in general purpose and special-purpose computing systems, or other devices having processing capability. Generally, any of the functions described with reference to the figures can be implemented using software, hardware (e.g., fixed logic circuitry) or a combination of these implementations. Thus, the processes, components and modules described herein can be implemented by a computer program product.

Furthermore, this disclosure provides various example implementations, as described and as illustrated in the drawings. However, this disclosure is not limited to the implementations described and illustrated herein, but can extend to other implementations, as would be known or as would become known to those skilled in the art. Reference in the specification to “one example” “some examples,” “some implementations,” or similar phrases means that a particular feature, structure, or characteristic described is included in at least one implementation, and the appearances of these phrases in various places in the specification are not necessarily all referring to the same implementation.

### CONCLUSION

Although the subject matter has been described in language specific to structural features and/or methodological acts, the subject matter defined in the appended claims is not limited to the specific features or acts described above. Rather, the specific features and acts described above are disclosed as example forms of implementing the claims. This disclosure is intended to cover any and all adaptations or variations of the disclosed implementations, and the following claims should not be construed to be limited to the specific implementations disclosed in the specification. Instead, the scope of this document is to be determined entirely by the following claims, along with the full range of equivalents to which such claims are entitled.

1. A device comprising:
a plurality of keys, each of the plurality of keys for inputting data to a computing device in response to the key being pressed; and
a first sensor integrated with a surface of a first of the plurality of keys, the first sensor producing a first touch input signal in response to detecting a first touch input on the surface of the first of the plurality of keys.

2. The device according to claim 1, further comprising a second sensor integrated with a surface of a second of the plurality of keys, the second sensor producing a second touch input signal in response to detecting a second touch input on the surface of the second of the plurality of keys.

3. The device according to claim 1, wherein the key being pressed comprises the key being moved at least a first threshold distance.

4. The device according to claim 1, wherein the first touch input comprises a movement of the first touch input along the surface of the first of the plurality of keys.

5. The device according to claim 2, wherein the first sensor uses capacitive sensing and the second sensor uses capacitive sensing or optical finger navigation.

6. The device according to claim 2, wherein the first sensor and the second sensor are enabled in response to two or more of the plurality of keys being pushed at least a second threshold distance.

7. The device according to claim 2, wherein the first sensor and the second sensor are enabled in response to detecting, by a third sensor, an enabling touch input.

8. The device according to claim 7, wherein the enabling touch input further comprises the enabling touch input lasting for at least a threshold amount of time.

9. A device comprising:
a first sensor configured for use on a surface of a first of a plurality of keys of a keyboard, each of the plurality of keys for inputting data to a computing device in response to the key being pressed; and
producing a first touch input signal in response to detecting, by the first sensor, a first touch input on the surface of the first of the plurality of keys.

10. The device according to claim 9, further comprising a second sensor configured for use on a surface of a second of the plurality of keys, the second sensor producing a second touch input signal in response to detecting, by the second sensor, a second touch input.

11. The device according to claim 10, wherein the first sensor and the second sensor are enabled in response to detecting, be a third sensor configured for use on a surface of a third of the plurality of keys, a third touch input.

12. The device according to claim 11, wherein detecting the third touch input comprises detecting the third touch input by the third sensor for at least a threshold amount of time.

13. The device according to claim 10, wherein the first sensor and the second sensor are disabled in response to detecting a fourth touch input.

14. A computer-readable medium storing computer-executable instructions that, when executed, cause one or more processors to perform acts comprising:
detecting an enabling input associated with a keyboard, wherein each of a plurality of keys of the keyboard is configured for inputting a character, symbol, or number to a computing device in response to the key being pushed at least a first threshold distance;
enabling a first sensor in response to detecting the enabling input, wherein the first sensor is integrated with a surface of a first of the plurality of keys and;
receiving an indication that the first sensor has detected movement of a first touch input along the surface of the first plurality of keys; and
causing a pointer to be moved within a display associated with the computing device in response to receiving the indication of the movement of the first touch input.

15. The computer-readable medium of claim 14, wherein the acts further comprise:
enabling a second sensor in response detecting the enabling input, wherein the second sensor is integrated with a surface of a second of the plurality of keys; and
interpreting a second touch input from the second sensor as input associated with the pointer.

16. The computer-readable medium of claim 14, wherein the enabling input comprises two or more of the plurality of keys being pushed at least the first threshold distance.

17. The computer-readable medium of claim 14, wherein the enabling input comprises a third touch input on a surface of a third of the plurality of keys.

18. The computer-readable medium of claim 17, wherein the third touch input lasts for at least a threshold amount of time.

19. The computer-readable medium of claim 17, wherein detecting the first touch input, the second touch input, or the third touch input comprises determining that a respective one of the plurality of keys is not pushed more than a second threshold distance.

20. The computer-readable medium of claim 17, wherein the acts further comprise:
detecting a fourth touch input; and
disabling the first sensor and the second sensor in response to detecting the fourth touch input.
